(19) United States
(12) Patent Application Publication
(10) Pub. No.: US 2026/0039545 A1
(43) Pub. Date: Feb. 5, 2026

(54) ENERGY CONSERVATION USING FLEXIBLE SERIALIZER/DE-SERIALIZER PHY

(71) Applicant: Cisco Technology, Inc., San Jose, CA (US)

(72) Inventors: Sushant Susheelendra KULKARNI, San Jose, CA (US); Karthik THANGARAJ, Fremont, CA (US); Manish JHANJI, Santa Clara, CA (US); Peter GUNADISASTRA, Palo Alto, CA (US); Mohammad SAFIULLAH, Cupertino, CA (US)

(21) Appl. No.: 18/792,163

(22) Filed: Aug. 1, 2024

(51) Int. Cl. H04L 41/0816; H04L 41/0833; H04L 43/0876

(52) U.S. Cl. CPC H04L 41/0816; H04L 41/0833; H04L 43/0876

(57) ABSTRACT

In one embodiment, a method includes monitoring bandwidth utilization on a plurality of ports on a network switch and determining that the bandwidth utilization on the plurality of ports meets a criterion. The method further includes disabling at least one serializer/de-serializer component on the network switch in response to determining that the bandwidth utilization on the plurality of ports meets the criterion and reconfiguring a PHY on the network switch in response to disabling the at least one serializer/de-serializer component.

### TECHNICAL FIELD

The present disclosure relates generally to computer networks, and, more particularly, to energy conservation using flexible serializer/de-serializer and PHY.

### BACKGROUND

In modern computing networks, ports (e.g., downlink ports) associated with a network switch or switching fabric (e.g., a “switching platform” or “switch” for brevity) generally consume a set amount of power for operation of a serializer/de-serializer (SerDes) component and a set amount of power for operation of a PHY (physical layer) component regardless of the throughput of the ports of the switch. This generally results in a constant rate of power consumption for the switch.

For example, in the current paradigm where a typical 24-port or 48-port multi-gigabit (mGig) switch may be capable of supporting around 10G bandwidth to each port, it is common practice to operate all of the power consuming components (e.g., SerDes components, PHY components, ports, etc.) associated with the switch irrespective of the bandwidth utilization on the ports. This constant uptime of all of the power consuming components associated with the switch can lead to scenarios in which resources, such as electrical power, are consumed at a relatively high rate. This can in turn increase the operating cost of the switch.

Some approaches seek to reduce this constant rate of power consumption by disabling a SerDes lane when ports coupled to that particular SerDes lane are not in use in an effort to reduce the uptime of at least some of the power consuming components associated with the switch.

### BRIEF DESCRIPTION OF THE DRA WINGS

The embodiments herein may be better understood by referring to the following description in conjunction with the accompanying drawings in which like reference numerals indicate identically or functionally similar elements, of which:

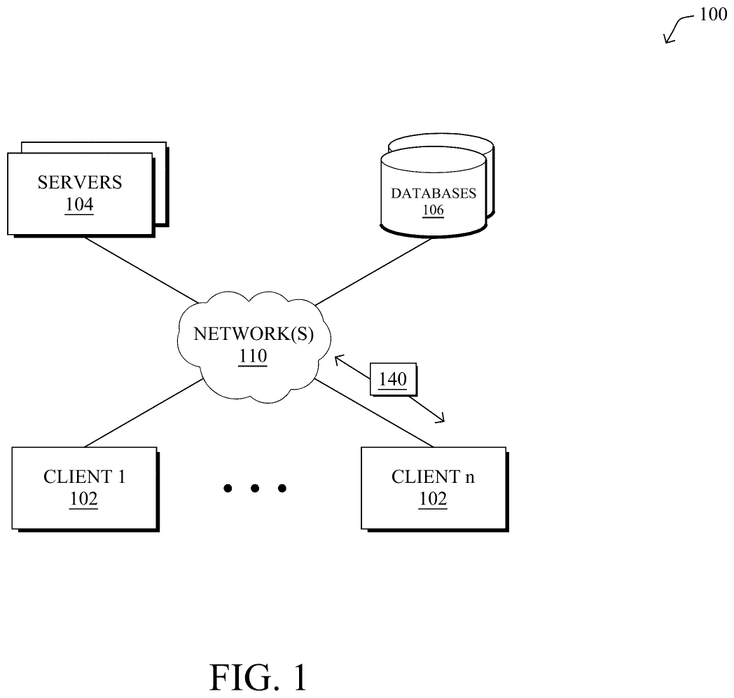

FIG. 1 illustrates an example computing system;

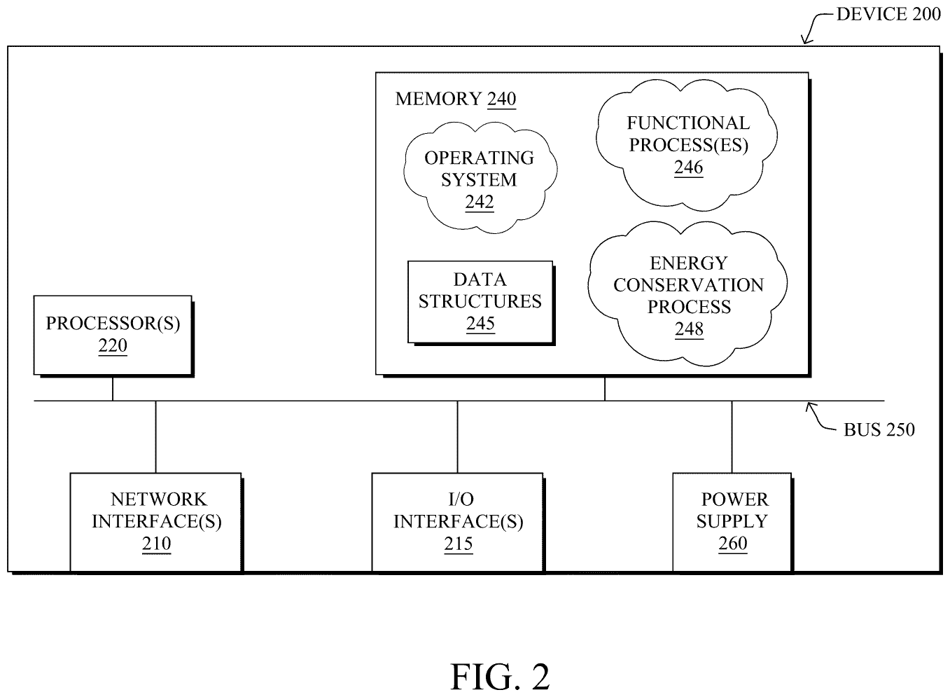

FIG. 2 illustrates an example network device/node;

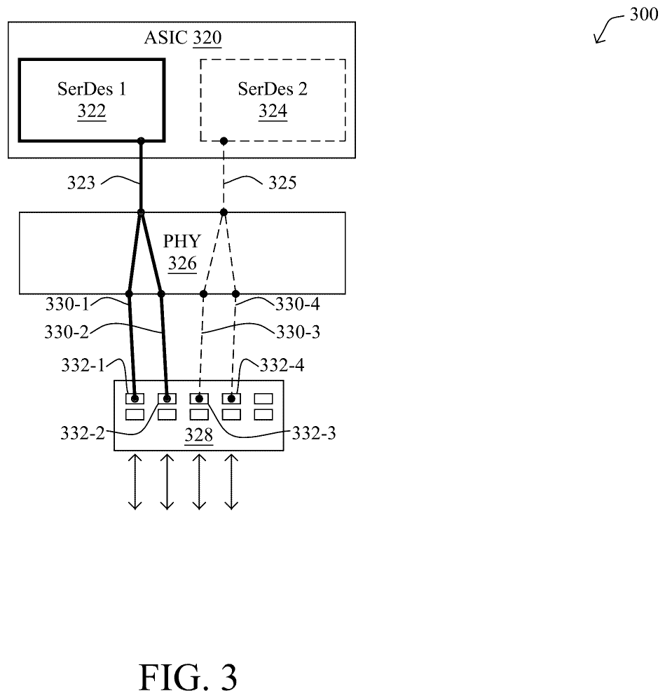

FIG. 3 illustrates an example switching platform in a normal operational mode;

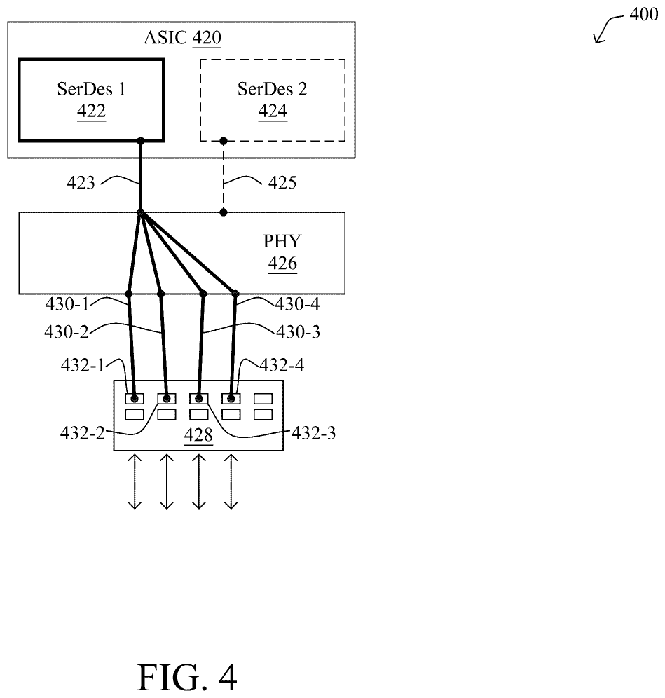

FIG. 4 illustrates an example switching platform in an energy conservation mode;

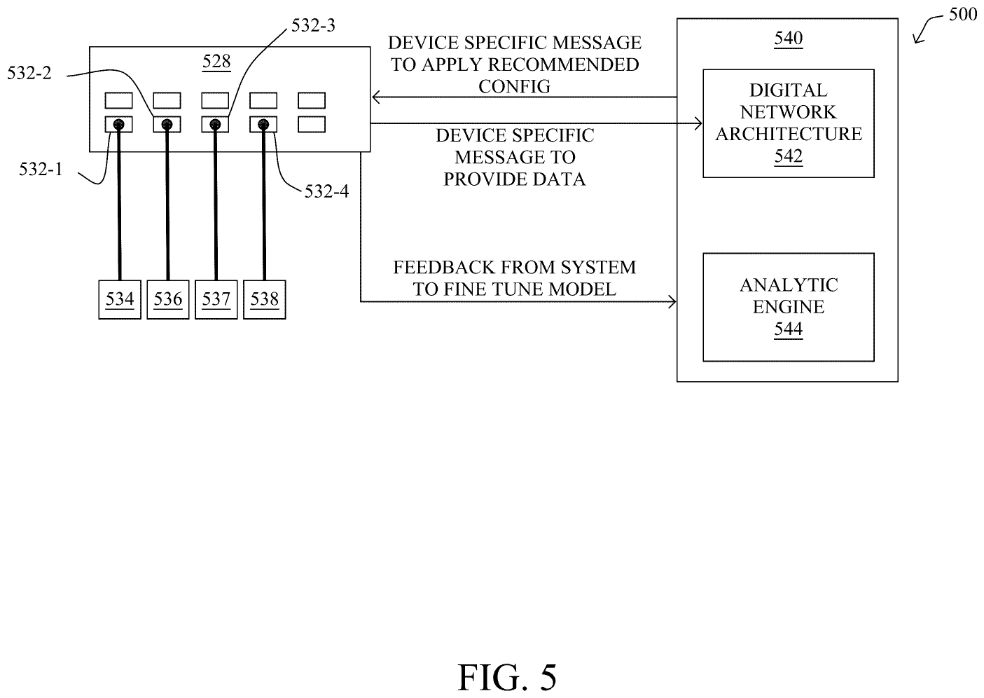

FIG. 5 illustrates an example system including a switch interface in communication with a network management platform;

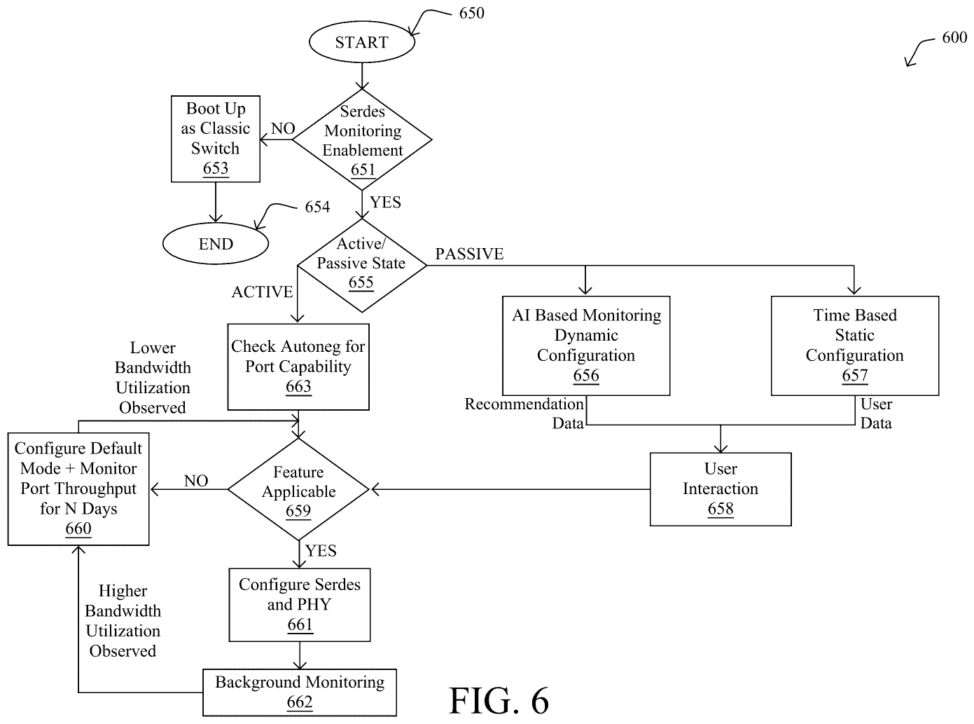

FIG. 6 illustrates an example flow for energy conservation using flexible serializer/de-serializer and PHY in accordance with the disclosure; and

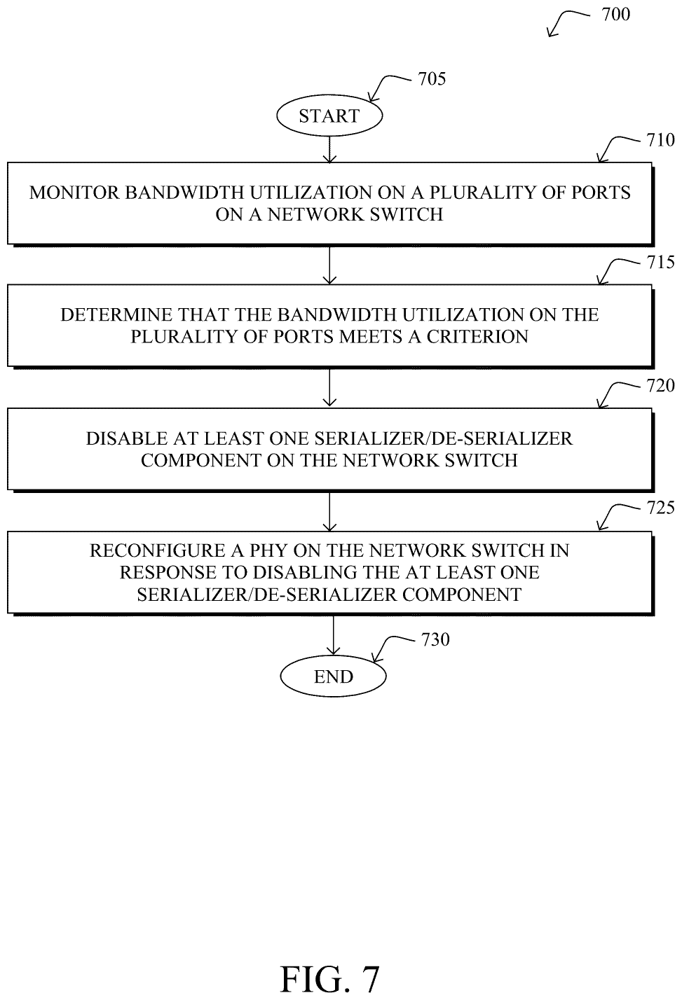

FIG. 7 illustrates an example procedure for energy conservation using flexible serializer/de-serializer and PHY in accordance with the disclosure.

### DESCRIPTION OF EXAMPLE EMBODIMENTS

### Overview

According to one or more embodiments of the disclosure, a method for energy conservation using flexible serializer/de-serializer and PHY includes monitoring bandwidth utilization on a plurality of ports on a network switch and determining that the bandwidth utilization on the plurality of ports meets a criterion. The method further includes disabling at least one serializer/de-serializer component on the network switch in response to determining that the bandwidth utilization on the plurality of ports meets the criterion and reconfiguring a PHY on the network switch in response to disabling the at least one serializer/de-serializer component.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through n′ client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, thereby forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an energy conservation process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms for source routing techniques. That is, for source routing, other devices in the network can tell the less capable devices where to send the packets, and the less capable devices simply forward the packets as directed.

In various implementations, as detailed further below, one or more functional processes 246 and/or energy conservation process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### ——Energy Conservation Using Flexible Serializer/De-serializer and PHY——

As noted above, in modern computing networks, ports (e.g., downlink ports) associated with a network switch or switching fabric (e.g., a “switching platform” or “switch” for brevity) generally consume a set amount of power for operation of a serializer/de-serializer (SerDes) component and a set amount of power for operation of a PHY component regardless of the throughput of the ports of the switch. This generally results in a constant rate of power consumption for the switch irrespective of the bandwidth utilization on the ports. This constant uptime of all of the power consuming components associated with the switch can lead to scenarios in which resources, such as electrical power, are consumed at a relatively high rate. This can in turn increase the operating cost of the switch.

Some approaches seek to reduce this constant rate of power consumption by disabling a SerDes lane when ports coupled to that particular SerDes lane are not in use in an effort to reduce the uptime of at least some of the power consuming components associated with the switch. However, this leads to a reduction in the available number of ports for communication thereby reducing the efficacy of the switch.

The techniques herein therefore provide a mechanism by which one or more SerDes components can be selectively disabled to reduce the uptime of at least some of the power consuming components associated with the switch. As described in more detail herein, when a SerDes component is selectively disabled in accordance with the techniques herein, the PHY can be reconfigured to continue to provide connectivity to the ports that were operational prior to the SerDes component being selectively disabled. This can lead to an optimization of bandwidth utilization of the ports which can in turn reduce the amount of power consumed in operating the switch while still allowing for traffic to traverse the ports. In an example implementation, the power savings can be on the order of 50 W (Watts) versus a typical 125 W generally consumed in operating a 48-port mGig switch in state-of-the-art approaches.

Specifically, according to one or more embodiments of the disclosure as described in detail below, a method includes monitoring bandwidth utilization on a plurality of ports on a network switch and determining that the bandwidth utilization on the plurality of ports meets a criterion. The method further includes disabling at least one serializer/de-serializer component on the network switch in response to determining that the bandwidth utilization on the plurality of ports meets the criterion and reconfiguring a PHY on the network switch in response to disabling the at least one serializer/de-serializer component.

Operationally, FIG. 3 illustrates an example switching platform 300 in a normal operational mode. As shown in FIG. 3, the example switching platform 300 (referred to for brevity as a “switch”) includes an application-specific integrated circuit (i.e., the ASIC 320) that includes a plurality of SerDes components (e.g., a first SerDes component 322, a second SerDes component 324, etc.). Although illustrated as having two discrete SerDes components, it will be appreciated that the ASIC 320 may include more than two discrete SerDes components.

In the example of FIG. 3, the first SerDes component 322 is coupled via a first communication path 323 to a PHY component (e.g., the PHY 326), while the second SerDes component 324 is coupled via a second communication path 325 to the PHY 326. In some implementations, the first SerDes component 322 and the second SerDes component 324 can be configured to provide 20G bandwidth across the first communication path 323 and the second communication path 325, respectively. That is, in some implementations, the first SerDes component 322 can support communication at 20G bandwidth to two ports (e.g., a first port 332-1 and a second port 332-2) across the PHY 326 such that the first port 332-1 receives communications at 10G bandwidth and the second port 332-2 receives communications at 10G bandwidth. Similarly, the second SerDes component 324 can support communication at 20G bandwidth to two ports (e.g., a third port 332-3 and a fourth port 332-4) across the PHY 326 such that the third port 332-3 receives communications at 10G bandwidth and the fourth port 332-4 receives communications at 10G bandwidth.

Stated alternatively, in the example shown in FIG. 3, the ASIC 320 and the PHY 326 may be configured with two 20G SerDes lanes (e.g., via a first communication path 323 and a second communication path 325) capable of supporting 10G per SerDes component on two ports that are coupled to the respective SerDes components. It will, however, be appreciated that implementations are not limited to this illustrative example and additional bandwidth capabilities, quantities of SerDes components, quantities of SerDes lanes, quantities of ports, etc. are contemplated within the scope of the disclosure.

Returning to the structure of the example switching platform 300 of FIG. 3, the PHY 326 is communicatively coupled to a switch interface 328 through the PHY 326 via a plurality of channels (e.g., a first channel 330-1, a second channel 330-2, a third channel 330-3, a fourth channel 330-4, etc., which may be referred to herein collectively as “channels 330”). As shown in FIG. 3, the channels 330 are communicatively coupled to ports (e.g., a first port 332-1, a second port 332-2, a third port 332-3, a fourth port 332-4, which may be referred to herein collectively as “ports 332”) of the switch interface 328.

As used herein, the term “switch interface” generally refers to a physical device that contains the components of the example switching platform 300. For example, the switch interface 328 generally refers to a physical device and/or form factor device that includes all or some of the components of the example switching platform 300, such as the ASIC 320, the first SerDes component 322, the second SerDes component 324, the PHY 326, channels 330, the ports 332, etc.

As mentioned above, in FIG. 3, the first SerDes component 322 is communicatively coupled to the PHY 326 via the first communication path 323 and the second SerDes component 324 is communicatively coupled to the PHY 326 via the second communication path 325. The PHY 326 then provides communications across the channels 330 to the ports 332.

That is, the first SerDes component 322 can provide communication at a given bandwidth (e.g., 20G bandwidth) across the first communication path 323 and the PHY 326 can provide communication at a given bandwidth (e.g., 10G per channel) across the first channel 330-1 and the second channel 330-2 to the first port 332-1 and the second port 332-2, respectively. Similarly, the second SerDes component 324 can provide communication at a given bandwidth (e.g., 20G bandwidth) across the second communication path 325 and the PHY 326 can provide communication at a given bandwidth (e.g., 10G per channel) across the third channel 330-3 and the fourth channel 330-4 to the third port 332-3 and the fourth port 332-4, respectively.

However, as mentioned above, methodologies that employ constant uptime to the ports 332, as shown in the example of FIG. 3, may result in a constant rate of power consumption for the switch irrespective of the bandwidth utilization on the ports 332. This constant uptime of all the power consuming components associated with the switch can lead to scenarios in which resources, such as electrical power, are consumed at a relatively high rate, which can increase the operating cost of the switch.

FIG. 4 illustrates an example switching platform 400 in an energy conservation mode. As shown in FIG. 4, the example switching platform 400 (referred to for brevity as a “switch”) includes an application-specific integrated circuit (i.e., the ASIC 420) that includes a plurality of SerDes components (e.g., a first SerDes component 422, a second SerDes component 424, etc.). Although illustrated as having two discrete SerDes components, it will be appreciated that the ASIC 420 may include more than two discrete SerDes components. The example switching platform 400, the ASIC 420, the first SerDes component 422, the second SerDes component 424, etc. can be analogous to the example switching platform 300, the ASIC 320, the first SerDes component 322, the second SerDes component 324, etc. of FIG. 3, respectively. Further, the PHY 426 and the switch interface 428 can be analogous to the PHY 326 and the switch interface 328 of FIG. 3, respectively.

In contrast to the operating mode of the switching platform 300 of FIG. 3, the switching platform 400 of FIG. 4 is running in an energy conservation mode. For example, as shown in FIG. 4, the second SerDes component 424 has been selectively disabled (e.g., the communication path 425 is disabled such that no data traffic traverses the communication path 425) and the PHY 426 has been reconfigured such that the first SerDes component 422 is providing communication at a particular bandwidth to the first port 432-1, the second port 432-2, the third port 432-3, and the fourth port 432-4.

In this example, the first SerDes component 422 can provide communication at a given bandwidth (e.g., 20G bandwidth) across the first communication path 423 and the PHY 426 can provide communication at a given bandwidth (e.g., 5G per channel) across the first channel 430-1, the second channel 430-2, the third channel 430-3, and the fourth channel 430-4 to the first port 432-1, the second port 432-2, the third port 432-3, and the fourth port 432-4, respectively. Although each port is now operating with a lower bandwidth usage than in the example of FIG. 3, this may be sufficient in many scenarios to operate endpoint devices that may not be 10G capable. Accordingly, a user of an endpoint device coupled to one of the ports in FIG. 4 may not notice the reduction in bandwidth usage; however, the energy consumption of the switching platform 400 can be reduced, as discussed above.

In some implementations, traffic analysis (e.g., artificial intelligence powered traffic analysis, machine learning powered traffic analysis, etc.) may be performed during runtime of the switching platform 400 to determine when it may be beneficial to enter the energy conservation mode shown in FIG. 4. The traffic analysis can include monitoring bandwidth utilization in the switching platform 400, among monitoring of other characteristics that may be seen during runtime of the switching platform 400. In the event that it is determined that the bandwidth utilization meets a particular criterion (or set or criteria), a SerDes components (the second SerDes component 424 in the example of FIG. 4) may be selectively disabled and the PHY 426 can be reconfigured to reduce the overall system power consumption while keeping necessary bandwidth usage and the quantity of operational ports intact.

Although shown as two discrete SerDes components with the first SerDes components 422 supporting up to 5G on each of four ports while the second SerDes component 424 is disabled, implementations are not so limited and, in other implementations, one or more SerDes components may support up to 2.5G on each of eight ports while one or more other SerDes components are disabled, etc.

In some implementations, the traffic analysis may be performed by a traffic monitoring component. The traffic monitoring component can include machine-readable instructions that are executed by a processing device to perform operations consistent with analyzing the traffic in the switching platform 400. Implementations are not so limited, however, and in some implementations, the traffic monitoring component can be a hardware device, such as an ASIC, FPGA, etc., an application programming interface, or other suitable component that is configured to perform traffic analysis in the switching platform 400.

In implementations in which the traffic analysis is powered by the use of artificial intelligence, it is noted that, in general, time series data is a transformative force, as this data can be vital for network monitoring as it offers valuable insights into the performance, behavior, and trends of network systems over time. In order to leverage these insights, Port Network Traffic Analysis (PNTA) can utilize machine learning and rule-based detection to spot low bandwidth utilization in order to determine whether the bandwidth utilization meets the particular criterion (or set or criteria). In some implementations, PNTA can be performed prior to alerting the user to act on a recommendation to enter the energy conservation mode to save more power and/or prior to the switching platform 400 taking any automatic actions to enter the energy conservation mode to save more power. In some implementations, the computational training and/or model evaluation can be offloaded to a network management platform, such as the network management platform 540 discussed in more detail in connection with FIG. 5, herein.

As mentioned above, in the event that it is determined that the bandwidth utilization meets a particular criterion (or set of criteria), a SerDes components (the second SerDes component 424 in the example of FIG. 4) may be selectively disabled and the PHY 426 can be reconfigured to reduce the overall system power consumption in response to a user command. In such implementations, the traffic analysis component may provide information regarding the bandwidth usage of the switching platform 400 to a user via, for example, a user interface, and the user can decide whether or not to activate the energy conservation mode. Implementations are not so limited, however, and in some implementations, the traffic analysis component can automatically cause the switching platform 400 to enter the energy conservation mode in response to the particular criterion (or set of criteria) being met. In such implementations, the traffic analysis component can be configured to provide a report to a user of the switching platform 400 informing the user what actions were taken, when such actions were taken, etc.

FIG. 5 illustrates an example system 500 including a switch interface 528 in communication with a network management platform 540 in accordance with the disclosure. As shown in FIG. 5, various downlink components are coupled to ports of the switch interface 528. For example, a first device 534 may be coupled to a first port 532-1, a second device 536 may be coupled to a second port 532-2, a third device 537 may be coupled to a third port 532-3, and a fourth device 538 may be coupled to a fourth port 532-4. The first port 532-1, second port 532-2, third port 532-3, and fourth port 532-4 (which may be referred to herein for brevity as the “ports 532”) may be analogous to the ports 432 of FIG. 4 and/or the ports 332 of FIG. 3, herein. Further, the deceives (e.g., the first device 534, the second device 536, the third device 537, the fourth device 538, etc.) may be various devices, such as computers, laptops, wireless access point(s), etc., as will be appreciated by those of ordinary skill in the art.

Continuing with the example of FIG. 5, as mentioned above, Port Network Traffic Analysis (PNTA) can be employed to utilize machine learning and rule-based detection to spot low bandwidth utilization in the system 500 prior to alerting the user to act on a recommendation to enter the energy conservation mode to reduce power consumption and/or prior to the system 500 taking any automatic actions to enter the energy conservation mode to reduce power consumption. In such implementations, the computational, training, and/or model evaluation processes can be offloaded to the network management platform 540, which can use telemetry data to perform the PNTA, as well as any machine learning and/or artificial intelligence operations in accordance with the disclosure. Non-limiting examples of a network management platform 540 can include, but are not limited to, Cisco Catalyst center by Cisco® Systems, Inc., Meraki Cloud by Cisco® Systems, Inc., or other suitable network management platforms.

As shown in FIG. 5, the network management platform 540 includes a digital network architecture 542 and an analytic engine 544. The digital network architecture 542 can be a software-driven network architecture that provides constant visibility into traffic patterns associated with the system 500, leverages machine learning at scale to provide increasing intelligence to the system 500, and/or enables the system 500 (e.g., a network) with the ability to monitor and predict issues and threats so that a user of the system 500 can respond faster to changes in the traffic patterns within the system 500. In some implementations, the analytic engine 544 can provide analysis (e.g., layer 2 analysis) of analytics, such as telemetry data, observed during operation of the system 500. The analytic engine 544 can generate and/or analyze various models (e.g., time series, regression, etc.) based on the analytics collected by the network management platform 540. This can assist in the construction, analysis, and/or implementation of machine learning models and/or artificial intelligence processes that are based on data collected by the network management platform 540 in order to facilitate implementations of the present disclosure.

In a non-limiting example involving the system 500 of FIG. 5, a device specific message to provide data involving the switch interface 528 and the devices connected thereto can be sent to the network management platform 540. This data can then be analyzed by the components of the network management platform 540 to provide information regarding the bandwidth consumption, power usage, and/or potential power savings that could be provided if the switch interface 528 (and, accordingly, the switching platform 400 of FIG. 4) is operated in the energy conservation mode described above. In some implementations, this information can be provided to a user so that the user can determine whether or not to activate the energy conservation mode, or this information may be processed within the system 500 to automatically determine whether or not to activate the energy conservation mode.

In general, the system 500 of FIG. 5 can perform the following operations in accordance with the disclosure:
Data Collection: The above discussed data can be gathered at regular time intervals. In some implementations, the data may be gathered in response to commands provided to the switching platform. In the example of FIG. 5, the data may be collected on per port basis and provided to network management platform 540 as telemetry data. The above data collection can be rule-based to recognize the bandwidth utilization pattern. For example, a periodic data collection window on the order of weeks or months could be used in accordance with the disclosure, although other rule-based data collection methodologies and/or timeframe windows are contemplated herein. Non-limiting examples of data that can be collected to determine traffic patterns associated with the switching platform may include, but are not limited to:
   Peer device speed capability via auto negotiation;
   PHY power consumption;
   ASIC power consumption;
   SerDes bandwidth utilization; and/or
   Port configuration.
Data Preprocessing: At this stage, the collected data can be prepared for analysis by cleaning, normalizing, and/or transforming the data. In a non-limiting simplified example, the data can, according to different characteristics, be classified into workdays and non-workdays. Non-workdays mainly include weekends, holidays, and equipment maintenance days. Accordingly, in this example, the time series may first be divided into workday data sets and non-working data sets according to the data features, using the SDK-Means++ algorithm or another suitable algorithm.
Model Selection: At this stage, predictive modeling techniques may be applied, which can include the utilization of time-series forecasting models like ARIMA or LSTM (Long Short-Term Memory). In the long-term prediction of the behavior of such datasets, RMSE, MAE MAPE, and/or R2 models may be used, although implementations are not so limited.
Deployment and Integration: At this stage, an accurate recommendation based on the determined bandwidth consumption can be provided to a user along with a total amount of current power usage and power saving data report. Based on this recommendation, a network admin or other user can perform an action (e.g., by entering a command, such as a cli command, etc.) to cause the system 500 to be reconfigured as discussed above in connection with FIG. 4.
Feedback Loop: In some implementations, a feedback loop can be provided from switch to transmit data over to the network management platform 540 to improve the accuracy and effectiveness of the machine learning models discussed above. This feedback loop can help in refining the models and addressing false positives/negatives, thereby further improving the recommendations provided with respect to entering the energy conservation mode.

FIG. 6 illustrates an example flow 600 for energy conservation using flexible serializer/de-serializer and PHY in accordance with the disclosure. The flow 600 may start at operation 650 and continue to operation 651 where a determination is made as to whether or not SerDes monitoring capabilities are enabled. If SerDes monitoring capabilities are not enabled, the flow 600 continues to operation 653, the switch is booted in a normal operating mode, and the flow 600 ends at operation 654.

If, at operation 651 it is determined that SerDes monitoring capabilities are enabled, the flow 600 continues to operation 655 where a determination is made as to whether an active state (e.g., “active mode”) or passive state (e.g., passive mode) is selected carry out the SerDes monitoring capabilities. Active mode and passive mode are summarized below:
Active Mode: When the network administrator selects this option, the optimization is performed without user interaction but upon any config change, the user will be notified.
   When the end devices are connected, ports of a same SerDes group are considered for optimization before linking up.
   A wait time is initiated to determine the device capability of ports that are in use.
   Upon timer expiry the links are configured to be in default mode of 10G bandwidth and boot up is performed as it would be for a standard switch.
   If the devices on the ports are of 5G bandwidth, which is determined during auto negotiation (or eight devices with 2.5G bandwidth), an efficient power saving mode (e.g., the energy conservation mode) can be selected and applied.
   A monitoring system can then be active in the background to determine any higher bandwidth requirement or changes that may occur while the system is operating in the energy conservation mode.
   If one or more devices require 10G bandwidth support, then the system can perform AI-based pattern recognition to determine, for example, the time slot where the traffic is low. During this period of the day, configs can be applied and during peak hours, default configs can be reapplied to provide the necessary system performance.
Passive Mode: This mode uses user input to act on the recommendation provided by the system or based on AI generated or based on a static time-based rule. In this mode, the system is monitored to learn the network topology, traffic patterns, bandwidth, and power utilization and a comprehensive report is generated and provided to the user for best practices (e.g., what possibilities are there to save the power on the system). The comprehensive report and/or a recommendation including a recommended set of configs to save power if applicable are provided to the user.
   Dynamic configuration based on AI—as explained above, traffic analysis is performed using AI and a recommendation is provided to a user. The system learns the traffic based on the data and provides suggestions to improve energy consumption.
   Static configuration time-based rule—The user can provide the time slot of the day to select efficient power saving mode if the user is aware of low network usage hours. Such as in a typical office environment of 9-5 workday which is considered to be a high peak hour's slot and during nighttime a low peak hour's slot.

Returning to the flow 600 of FIG. 6, if, at operation 655 the active mode is selected, the flow 600 continues to operation 663 where autonegotiation operations can be performed to check and/or determine port capability. Assuming that, at operation 663, the autonegotiation operations determine that the ports are capable for handling data traffic, the flow 600 continues to operation 659 where a determination is made as whether the features disclosed herein are applicable (e.g., whether the power savings/energy conservation mode is to be entered). If not, the flow 600 continues to operation 660 where the default mode is configured and the switching platform operates in a standard manner.

However, if it is determined at operation 659 that the power savings/energy conservation mode can be entered, the flow 600 continues to operation 661 where the SerDes components and PHY are configured as discussed above in connection with FIG. 4. At operation 662, background monitoring is performed to determine any higher bandwidth requirement or changes that may occur while the system is operating in the energy conservation mode. If it is determined that a higher bandwidth utilization is observed, the flow 600 continues to operation 660 where the default mode is configured and the switching platform operates in a standard manner.

Returning to operation 655, if the passive mode is selected, the flow 600 continues to operation 656 where, as described above, AI-based monitoring and configuration operations are performed. In addition, when the passive mode is selected, the flow 600 also continues to operation 657 where time-based static reconfiguration operations may be performed. Performance of operation 656 and of operation 657 can yield a recommendation that is provided to the user (as discussed above) and, at operation 658, user interaction may be requested to allow the system to enter the energy conservation mode.

It is worth noting that implementations are not limited to the operations of FIG. 6, and in some implementations, Wake-on-LAN (WoL) methodologies may be implemented at operation 650, operation 651, etc. In such implementations, when a computing device is turned on or woken up from a sleep or powered-off state by a network message (commonly referred to as a “magic packet” when the system in is WoL mode), the flow 600 can be initiated while in the energy conservation mode.

For example, in implementations where the system is in the energy conservation mode and the WoL mode simultaneously, the “magic packet” can still be received by the system even if one or more of the communication channels described above are disabled, thereby triggering performance of one or more operations of the flow 600. In such implementations, power consumption for the system can be reduced in scenarios in which the WOL feature is enabled, and the energy conservation mode is enabled by reducing the number of ports that are enabled until receipt of the “magic packet.”

FIG. 7 illustrates an example procedure for energy conservation using flexible serializer/de-serializer and PHY in accordance with the disclosure. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, bandwidth utilization on a plurality of ports on a network switch is monitored. In some implementations, as discussed above, the bandwidth utilization can be monitored using an artificial intelligence algorithm or other suitable machine learning technique or techniques.

The procedure 700 may continue to step 715 where, as described in greater detail above, it is determined that the bandwidth utilization on the plurality of ports meets a criterion.

The procedure 700 may continue to step 720 where, as described in greater detail above, at least one serializer/de-serializer component on the network switch is disabled in response to determining that the bandwidth utilization on the plurality of ports meets the criterion. In some implementations, the at least one serializer/de-serializer component can be disabled while one or more ports coupled to the at least one serializer/de-serializer component is disabled are in use (e.g., while such ports are sending or receiving information).

In some implementations, the procedure 700 can include disabling the at least one serializer/de-serializer component and reconfiguring the PHY automatically in an absence of an instruction from a user. In such implementations, the procedure 700 can further include reporting that the at least one serializer/de-serializer component was disabled and that the PHY was reconfigured in response to disabling the at least one serializer/de-serializer component and reconfiguring the PHY automatically. Implementations are not so limited, however, and in some implementations, the procedure 700 can include disabling the at least one serializer/de-serializer component and reconfiguring the PHY in response to a user command.

Further, as discussed above, in some implementations, the procedure 700 can include disabling the at least one serializer/de-serializer component and reconfiguring the PHY at a particular time selected from a group of times consisting of: a time of a particular day, a day of a particular week, and one more particular days of a given month. It will be appreciated that implementations are not limited to these enumerated examples and the serializer/de-serializer component can be disabled and/or the PHY can be reconfigured at any time or time interval, whether at regularly scheduled times or on an ad hoc basis in response to bandwidth usage amounts observed by the system.

The procedure 700 may continue to step 725 where, as described in greater detail above, a PHY on the network switch is reconfigured in response to disabling the at least one serializer/de-serializer component. In some implementations, the PHY can be reconfigured to reduce an amount of power consumed by the network switch. Implementations are not so limited, however, and in other implementations, the PHY can be reconfigured to reduce an amount of bandwidth used by the network switch.

In some implementations, the procedure 700 can include reconfiguring the PHY such that a serializer/de-serializer component that is not disabled becomes coupled to the one or more ports coupled to the at least one serializer/de-serializer component that is disabled. In addition to, or in the alternative, in some implementations, the procedure 700 can include reconfiguring the PHY while the network switch is in an operational mode.

In some implementations, the procedure 700 can include determining that the bandwidth utilization on the plurality of ports no longer meets the criterion, re-enabling the at least one serializer/de-serializer component on the network switch in response to determining that the bandwidth utilization on the plurality of ports no longer meets the criterion, and reconfiguring the PHY on the network switch in response to re-enabling the at least one serializer/de-serializer component. This can allow for the system to be returned to a normal operational mode where none of the ports are disabled.

Procedure 700 may end at step 730.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: monitoring bandwidth utilization on a plurality of ports on a network switch; determining that the bandwidth utilization on the plurality of ports meets a criterion; disabling at least one serializer/de-serializer component on the network switch in response to determining that the bandwidth utilization on the plurality of ports meets the criterion; and reconfiguring a PHY on the network switch in response to disabling the at least one serializer/de-serializer component.

In still other implementations, a tangible, non-transitory, computer-readable medium storing program instructions that cause a device to execute a process comprising: monitoring bandwidth utilization on a plurality of ports on a network switch; determining that the bandwidth utilization on the plurality of ports meets a criterion; disabling at least one serializer/de-serializer component on the network switch in response to determining that the bandwidth utilization on the plurality of ports meets the criterion; and reconfiguring a PHY on the network switch in response to disabling the at least one serializer/de-serializer component.

The techniques described herein, therefore, provide for energy conservation using flexible serializer/de-serializer and PHY. As discussed above, the techniques herein provide a mechanism by which one or more SerDes components can be selectively disabled to reduce the uptime of at least some of the power consuming components associated with the switch. When a SerDes component is selectively disabled in accordance with the techniques herein, the PHY can be reconfigured to continue to provide connectivity to the ports that were operational prior to the SerDes component being selectively disabled. This can lead to a reduction in the bandwidth utilization of the ports which can in turn reduce the amount of power consumed in operating the switch while still allowing for traffic to traverse the ports. In an example implementation, the power savings can be on the order of fifty Watts (W) versus a typical one hundred and twenty-five W generally consumed in operating a 48 port mGig switch in state-of-the-art approaches. The techniques here may be particularly useful in places where network usage is somewhat predictable, such as office environments, retail centers, malls, exhibition centers, etc. However, the techniques described herein are not limited to application in these example locations.

Illustratively, the techniques described herein may be performed by hardware, software, and/or firmware, (e.g., an “apparatus”) such as in accordance with the energy conservation process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
monitoring bandwidth utilization on a plurality of ports on a network switch;
determining that the bandwidth utilization on the plurality of ports meets a criterion;
disabling at least one serializer/de-serializer component on the network switch in response to determining that the bandwidth utilization on the plurality of ports meets the criterion; and
reconfiguring a PHY on the network switch in response to disabling the at least one serializer/de-serializer component.

2. The method of claim 1, further comprising:
monitoring the bandwidth utilization using an artificial intelligence algorithm.

3. The method of claim 1, further comprising:
reconfiguring the PHY to reduce an amount of power consumed by the network switch.

4. The method of claim 1, further comprising:
reconfiguring the PHY to reduce an amount of bandwidth used by the network switch.

5. The method of claim 1, further comprising:
disabling the at least one serializer/de-serializer component while one or more ports coupled to the at least one serializer/de-serializer component is disabled are in use.

6. The method of claim 5, further comprising:
reconfiguring the PHY such that a serializer/de-serializer component that is not disabled becomes coupled to the one or more ports coupled to the at least one serializer/de-serializer component that is disabled.

7. The method of claim 1, further comprising:
reconfiguring the PHY while the network switch is in an operational mode.

8. The method of claim 1, further comprising:
disabling the at least one serializer/de-serializer component and reconfiguring the PHY automatically in an absence of an instruction from a user.

9. The method of claim 8, further comprising:
reporting that the at least one serializer/de-serializer component was disabled and that the PHY was reconfigured in response to disabling the at least one serializer/de-serializer component and reconfiguring the PHY automatically.

10. The method of claim 1, further comprising:
disabling the at least one serializer/de-serializer component and reconfiguring the PHY in response to a user command.

11. The method of claim 1, further comprising:
disabling the at least one serializer/de-serializer component and reconfiguring the PHY at a particular time selected from a group of times consisting of: a time of a particular day, a day of a particular week, and one more particular days of a given month.

12. The method of claim 1, further comprising:
determining that the bandwidth utilization on the plurality of ports no longer meets the criterion;
re-enabling the at least one serializer/de-serializer component on the network switch in response to determining that the bandwidth utilization on the plurality of ports no longer meets the criterion; and
reconfiguring the PHY on the network switch in response to re-enabling the at least one serializer/de-serializer component.

13. An apparatus, comprising:
one or more network interfaces to communicate with a network;
a processor coupled to the one or more network interfaces and configured to execute one or more processes; and
a memory configured to store a process that is executable by the processor, the process comprising:
monitoring bandwidth utilization on a plurality of ports on a network switch;
determining that the bandwidth utilization on the plurality of ports meets a criterion;
disabling at least one serializer/de-serializer component on the network switch in response to determining that the bandwidth utilization on the plurality of ports meets the criterion; and
reconfiguring a PHY on the network switch in response to disabling the at least one serializer/de-serializer component.

14. The apparatus of claim 13, further comprising:
reconfiguring the PHY to reduce an amount of power consumed by the network switch or an amount of bandwidth consumed by the network switch.

15. The apparatus of claim 13, further comprising:
disabling the at least one serializer/de-serializer component while one or more ports coupled to the at least one serializer/de-serializer component is disabled are in use.

16. The apparatus of claim 13, further comprising:
reconfiguring the PHY such that a serializer/de-serializer component that is not disabled becomes coupled to one or more ports coupled to the at least one serializer/de-serializer component that is disabled.

17. The apparatus of claim 13, further comprising:
reconfiguring the PHY while the network switch is in an operational mode.

18. The apparatus of claim 13, further comprising:
disabling the at least one serializer/de-serializer component and reconfiguring the PHY at a particular time selected from a group of times consisting of: a time of a particular day, a day of a particular week, and one more particular days of a given month.

19. The apparatus of claim 13, further comprising:
determining that the bandwidth utilization on the plurality of ports no longer meets the criterion;
re-enabling the at least one serializer/de-serializer component on the network switch in response to determining that the bandwidth utilization on the plurality of ports no longer meets the criterion; and
reconfiguring the PHY on the network switch in response to re-enabling the at least one serializer/de-serializer component.

20. A tangible, non-transitory, computer-readable medium storing program instructions that cause a device to execute a process comprising:
monitoring bandwidth utilization on a plurality of ports on a network switch;
determining that the bandwidth utilization on the plurality of ports meets a criterion;
disabling at least one serializer/de-serializer component on the network switch in response to determining that the bandwidth utilization on the plurality of ports meets the criterion; and
reconfiguring a PHY on the network switch in response to disabling the at least one serializer/de-serializer component.
